(19) United States
(12) Patent Application Publication
(10) Pub. No.: US 2002/0085283 A1
(43) Pub. Date: Jul. 4, 2002

(54) Optical element and manufacturing method

(75) Inventors: Hiroyuki Hattori, Hachioji-shi (JP); Etsuzo Kurihara, Hachioji-shi (JP)

Correspondence Address: Finnegan, Henderson, Farabow, Garrett & Dunner, L.L.P., 1300 I Street, N.W., Washington, DC, 20005-3315, US

(73) Assignee: KONICA CORPORATION

(21) Appl. No.: 10/025,492

(22) Filed: Dec. 26, 2001

(30) Foreign Application Priority Data
Dec. 28, 2000 (JP) 402188/2000

(51) Int. Cl. G02B 5/18; G02B 27/44

(52) U.S. Cl. 359/566; 359/569

(57) ABSTRACT

An optical element molded between a first die and a second die which are jointed along a partition line, comprises a first optical surface on which a diffractive structure is provided; a second optical surface being a refractive surface opposite to the first optical surface; and a flange having a flange surface provided around a periphery of the optical element, a first edge portion of the flange surface adjoining to the first optical surface and a second edge portion of the flange surface adjoining to the second optical surface. The second edge portion is positioned at the partition line between the first die and second die.

### BACKGROUND OF THE INVENTION

The present invention relates to a manufacturing method of an optical element that forms the optical element through injection molding, and to the optical element.

An example of the optical element is a plastic lens which is used for an optical system of an optical equipment such as an optical pickup device and a camera. As a plastic lens of this type, there is plastic lens 100 which has on its one side a surface of diffractive structure 100a.

For the manufacture of the plastic lens 100, there is a method wherein resin is injected in a mold which is formed by metal mold 102 equipped with ejecting mechanism 101 for releasing a molding product and by metal mold 103 equipped with no ejecting mechanism as shown in FIG. 8, and then, the metal mold 102 equipped with ejecting mechanism 101 is moved for mold opening as shown in FIG. 9, and the ejecting mechanism 101 is actuated to eject the molding product representing plastic lens 100 to release it from the mold as shown in FIG. 10.

In the manufacture of a plastic lens stated above, metal mold 103 equipped with no ejecting mechanism has mold surface 103a that forms a surface of diffractive structure 100a of plastic lens 100. Therefore, if metal mold 102 equipped with ejecting mechanism 101 is deviated, even if the deviation is slight, in the direction perpendicular to the direction of its movement when the metal mold 102 is moved for mold opening, the diffractive structure 100a of the plastic lens 100 is sometimes deviated to be deformed in a moment of the mold opening.

Because of a weight of the metal mold 102 equipped with ejecting mechanism 101, it is not easy to restrain the deviation in the course of the mold opening, and this deviation sometimes makes the plastic lens 100 having the diffractive structure 100a to fail to obtain desired optical characteristics.

### SUMMARY OF THE INVENTION

The invention has been achieved in view of the problems mentioned above, and its object is to provide a manufacturing method of an optical element which is simple in structure and makes it possible to obtain accurate and desired optical characteristics and to provide the optical element.

To solve the aforesaid problems and to attain the object, the invention is structured as follows.

The invention described in (1) is a manufacturing method for an optical element having therein a metal mold on which a molding product remains when the mold is opened and a metal mold from which the molding product is released when the mold is opened, the metal mold on which a molding product remains when the mold is opened having thereon a mold surface that forms a microscopic step-wise surface like a diffractive structure on an optical element representing the molding product, a step of injecting resin in the mold formed by the metal mold on which a molding product remains when the mold is opened and a metal mold from which the molding product is released when the mold is opened, then, a step of opening the mold and thereby releasing the molding product representing the optical element from the metal mold on which the molding product remains when the mold is opened, and a step of manufacturing the optical element having on its one side a microscopic step-wise surface like a diffractive structure.

In the invention described in (1), resin is injected into the mold formed by the metal mold on which a molding product remains when the mold is opened and a metal mold from which the molding product is released when the mold is opened, then, mold opening follows, and when the mold is opened, even when deviation is caused between metal molds, the mold surface on the metal mold on which the molding product remains when the mold is opened is not deviated from the microscopic step-wise surface like a diffractive structure on an optical element, and then, the molding product representing the optical element is released from the metal mold, thus, it is possible to manufacture an optical element having thereon a microscopic step-wise surface like a diffractive structure which makes it possible to obtain accurate and desired optical characteristics under the simple structure.

The invention described in (2) is a manufacturing method for a plastic lens which has therein a metal mold equipped with an ejecting mechanism for releasing a molding product and a metal mold equipped with no ejecting mechanism, the metal mold equipped with an ejecting mechanism having thereon a mold surface that forms a microscopic step-wise surface like a diffractive structure on an optical element representing the molding product, a step of injecting resin in the mold formed by the metal mold equipped with an ejecting mechanism and a metal mold equipped with no ejecting mechanism, and a step of releasing the molding product representing the optical element by opening the mold and by actuating the ejecting mechanism, and manufactures the optical element having on its one side a microscopic stepwise surface like a diffractive structure.

In the invention described in (2), resin is injected into the mold formed by the metal mold equipped with the ejecting mechanism and a metal mold equipped with no ejecting mechanism, then, mold opening follows, and when the mold is opened, even when deviation is caused between metal molds, the mold surface on the metal mold equipped with the ejecting mechanism is not deviated from the microscopic step-wise surface like a diffractive structure on an optical element. Then, the ejecting mechanism is actuated to eject and release the molding product representing the optical element, thus, it is possible to manufacture an optical element having thereon a microscopic step-wise surface like a diffractive structure which makes it possible to obtain accurate and desired optical characteristics under the simple structure.

The invention described in (3) is the manufacturing method for an optical element described in Structure 1 or Structure 2 wherein the ejecting mechanism has on at least a part thereof a mold surface that forms a surface in a microscopic step-wise shape like a diffractive structure, and this ejecting mechanism is actuated to eject and release the molding product representing the optical element.

In the invention described in (3), the ejecting mechanism has on at least a part thereof a mold surface that forms a surface of the optical element in a microscopic stepwise shape like a diffractive structure, and therefore, when this ejecting mechanism is actuated to eject and release the molding product representing the optical element, the total surface of the diffractive structure of the optical element is ejected, thereby, the surface of the diffractive structure is not deviated, and thus, it is possible to manufacture an optical element having thereon a microscopic step-wise surface like a diffractive structure which makes it possible to obtain more accurate and desired optical characteristics.

The invention described in (4) is an optical element formed by the manufacturing method for an optical element described in either one of (1)-(3).

The invention described in (4) is an optical element having on its one side a surface in a microscopic step-wise shape like a diffractive structure which makes it possible to obtain highly accurate and desired optical characteristics.

### BRIEF DESCRIPTION OF THE DRAWINGS

FIG. 1 is a diagram showing the structure of a metal mold.

FIG. 2 is a diagram showing the condition wherein resin is injected in a metal mold.

FIG. 3 is a diagram showing mold opening of a metal mold,

FIG. 4 is a diagram showing how an ejecting mechanism operates.

FIG. 5 is a diagram showing a mold surface that forms a surface of a diffractive structure of a plastic lens and the surface of the diffractive structure of the plastic lens.

FIG. 6 is a side view of a plastic lens having on its one side a surface of a diffractive structure.

FIG. 7 is a side view of a conventional plastic lens having on its one side a surface of a diffractive structure.

FIG. 8 is a diagram showing the structure of a conventional plastic lens and a metal mold.

FIG. 9 is a diagram showing mold opening of a conventional metal mold.

FIG. 10 is a diagram showing how a conventional ejecting mechanism operates.

### DETAILED DESCRIPTION OF THE PREFERRED EMBODIMENT

Referring to the drawings, there will be explained the embodiment of the manufacturing method for an optical element in the invention and of the optical element, to which, however, the invention is not limited.

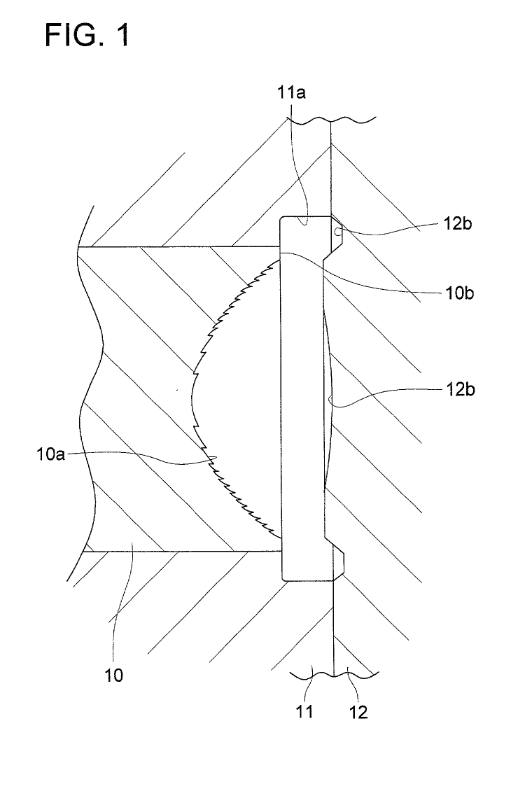

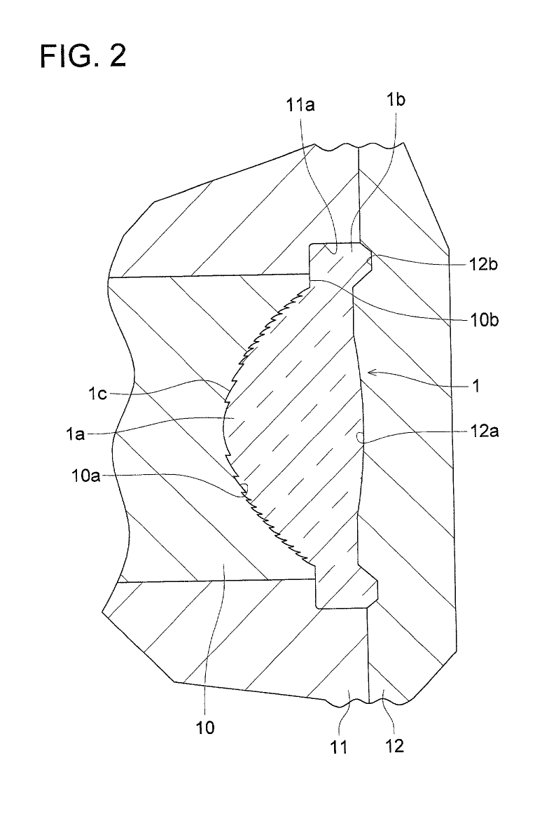

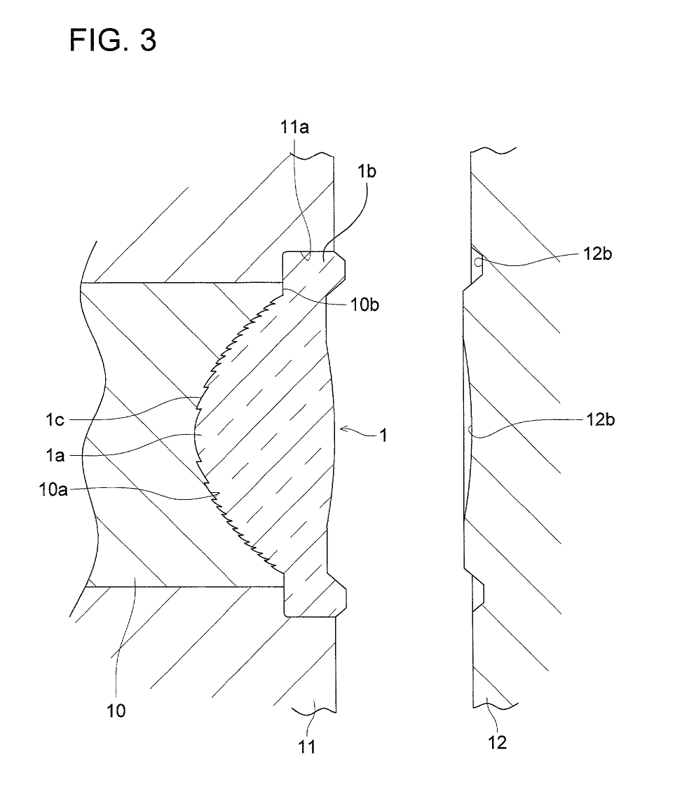

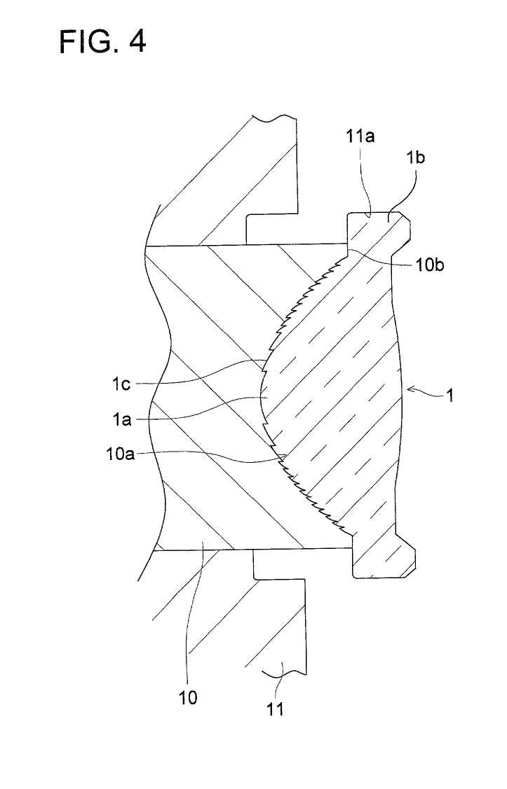

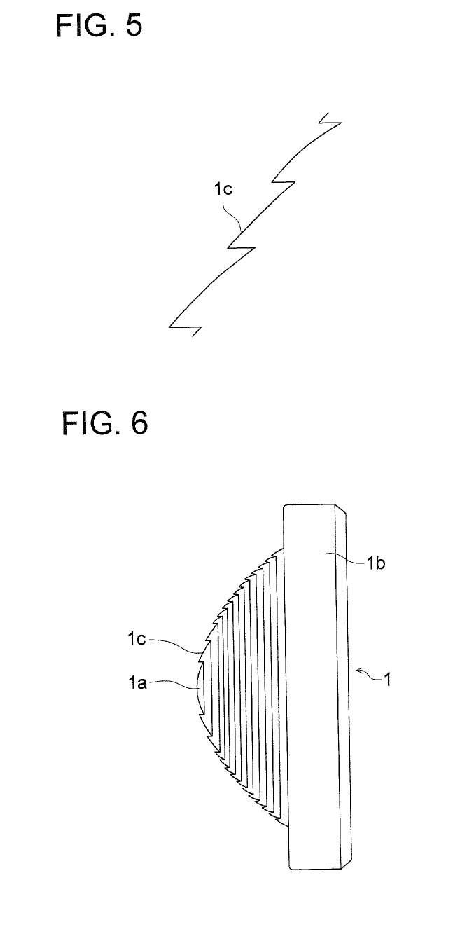

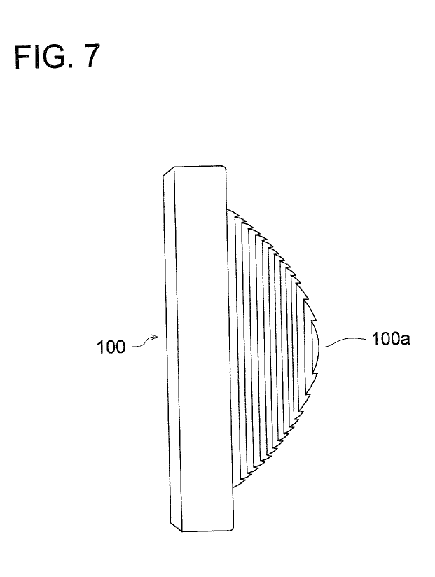

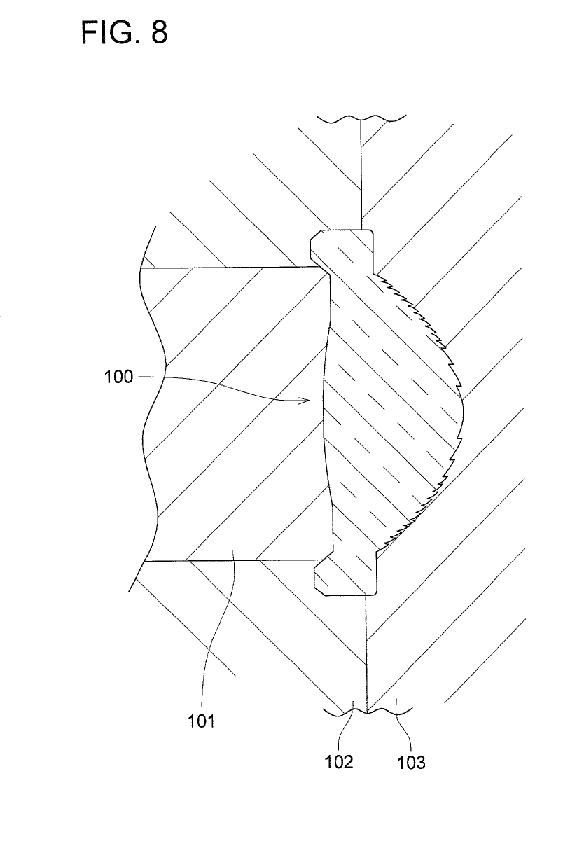

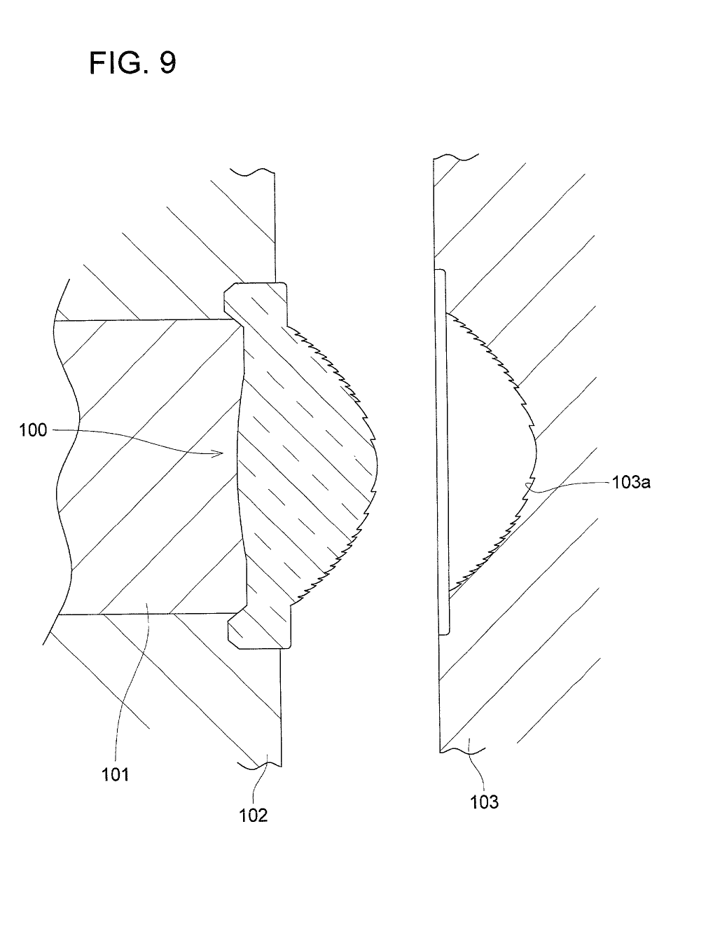

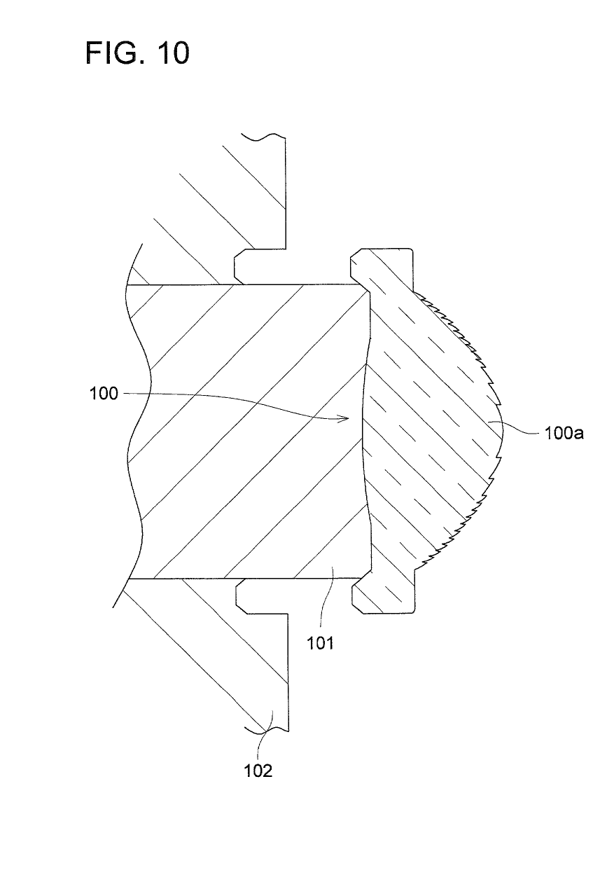

FIG. 1 is a diagram showing the structure of the metal mold, FIG. 2 is a diagram showing how resin is injected in the metal mold, FIG. 3 is a diagram showing the opened metal mold, FIG. 4 is a diagram showing how the ejecting mechanism operates, FIG. 5 is a diagram showing the mold surface which forms a surface of the diffractive structure of a plastic lens and showing a surface of the diffractive structure of the plastic lens, and FIG. 6 is a side view of the plastic lens having on its one side a surface of the diffractive structure.

A manufacturing apparatus of the present embodiment is one for manufacturing a plastic lens representing an optical element, and it is composed of metal mold 11 which is equipped with ejecting mechanism 10 that releases a molding product and is structured so that the molding product may remain thereon when the metal mold 11 is opened and of metal mold 12 which is not equipped with the ejecting mechanism and is structured so that the molding product may be released when the metal mold 12 is opened. The manufacturing apparatus is of the structure wherein the metal mold 12 is fixed and the metal mold 11 is moved, and it injection-molds plastic lens 1 which has on its one side a surface in a microscopic step-wise shape like a diffractive structure. The injection in the invention (injection molding) includes one for molding by injecting resin in a metal mold such as an injection compression molding.

The plastic lens representing an optical element in the present embodiment has optical functional section 1a and flange section 1b that is formed on the outer circumference of the optical functional section 1a. On the surface on one side of the optical functional section 1a, there is formed diffractive structure 1c that is in a microscopic step-wise shape so that highly accurate and desired optical characteristics may be obtained. Incidentally, though the flange section 1b is provided on the outer circumference of the optical functional section 1a of the plastic lens 1 in the present embodiment, the lens does not need to have the flange section, and it may further be a disk-shaped lens without being limited to a circular lens. In addition, the optical element may be a light-conductive object, without being limited to a plastic lens.

The metal mold 11 has mold surface 11a that forms flange section 1b of the plastic lens 1. The ejecting mechanism 10 has mold surface 10a that forms a surface of diffractive structure 1c of the optical functional section 1a of the plastic lens 1 and has mold surface 10b that forms a part of an inner side of the flange section 1b.

Incidentally, with regard to the ejecting mechanism 10, the total mold surface may also be made to be a mold surface that forms a surface of a diffractive structure of the optical functional section 1a, without forming the mold surface 10b that forms a part of an inner side of the flange section 1b.

The metal mold 12 has mold surface 12a that forms optical functional section 1a of the plastic lens 1 and mold surface 12b that forms flange section 1b.

Resin is injected in a mold shown in FIG. 2 which is formed by the metal mold 11 equipped with the ejecting mechanism 10 and by the metal mold 12 equipped with no ejecting mechanism, and is cooled. This injection of resin is conducted from a runner which is an unillustrated channel for injecting resin, and a gate portion of the runner is formed to be integrally with flange section 1b and is cut off in the succeeding gate cutting process.

After this cooling, the metal mold 11 equipped with ejecting mechanism 10 is moved to open the mold as shown in FIG. 3, and the ejecting mechanism 10 is actuated to eject and release a molding product representing plastic lens 1 as shown in FIG. 4.

Further, the ejecting mechanism 10 has on at least a part thereof mold surface 10a that forms a surface of diffractive structure 1c of plastic lens 1, and therefore, when this ejecting mechanism 10 is actuated to eject and release the molding product representing the plastic lens 1, the total surface of the diffractive structure 1c of the plastic lens 1 is ejected, thereby, the surface of the diffractive structure 1c is not deviated, and thus, it is possible to manufacture the plastic lens 1 having thereon diffractive structure 1c which makes it possible to obtain more accurate and desired optical characteristics.

Though the mold surface 10a that forms a surface of diffractive structure 1c of plastic lens 1 is formed to be in a serrated form in terms of a section as shown in FIG. 5, the invention does not need to be limited to the foregoing provided that the mold surface is in a shape that causes a diffraction phenomenon. Incidentally, it is preferable that a draft angle of the metal mold is zero (the direction of the serrated step of plastic lens 1 is in parallel with an optical axis of the plastic lens 1) as shown in FIG. 5, in view of the reduction of a loss of an amount of light, which offers an effect that the invention can further reduce a loss of an amount of light and can realize manufacture of that kind of plastic lens 1.

As stated above, resin is injected in a mold which is formed by metal mold 11 equipped with ejecting mechanism 10 and metal mold 12 equipped with no ejecting mechanism, and then, mold opening is conducted, and when the mold is opened, even when deviation is caused between metal molds, the mold surface 1a of the ejecting mechanism 10 is not deviated from the surface of diffractive structure 1c of plastic lens 1. After that, the ejecting mechanism 10 is actuated to eject and release the plastic lens 1, thus, it is possible to manufacture the plastic lens 1 having thereon a diffractive structure which makes it possible to obtain accurate and desired optical characteristics under the simple structure.

Though a surface of diffractive structure 1c of plastic lens 1 is formed by mold surface 10a of ejecting mechanism 10, and optical functional section 1a is ejected and released by ejecting mechanism 10 in the present embodiment, flange section 1b may also be ejected by the ejecting mechanism to be released without being limited to the foregoing, and in this case, the mold surface that forms a surface of diffractive structure 1c of the plastic lens 1 is formed on the metal mold 11 because the ejecting mechanism 10 and the metal mold 11 can be processed integrally.

As stated above, in the invention described in (1), resin is injected into the mold formed by the metal mold on which a molding product remains when the mold is opened and a metal mold from which the molding product is released when the mold is opened, then, mold opening follows, and when the mold is opened, even when deviation is caused between metal molds, the mold surface on the metal mold on which the molding product remains when the mold is opened is not deviated from the microscopic step-wise surface like a diffractive structure on an optical element, and then, the molding product representing the optical element is released from the metal mold, thus, it is possible to manufacture an optical element having thereon a microscopic step-wise surface like a diffractive structure which makes it possible to obtain accurate and desired optical characteristics under the simple structure.

In the invention described in (2), resin is injected into the mold formed by the metal mold equipped with the ejecting mechanism and a metal mold equipped with no ejecting mechanism, then, mold opening follows, and when the mold is opened, even when deviation is caused between metal molds, the mold surface on the metal mold equipped with the ejecting mechanism is not deviated from the microscopic step-wise surface like a diffractive structure on an optical element. Then, the ejecting mechanism is actuated to eject and release the molding product representing the optical element, thus, it is possible to manufacture an optical element having thereon a microscopic step-wise surface like a diffractive structure which makes it possible to obtain accurate and desired optical characteristics under the simple structure.

In the invention described in (3), the ejecting mechanism has on at least a part thereof a mold surface that forms a surface of the optical element in a microscopic stepwise shape like a diffractive structure, and therefore, when this ejecting mechanism is actuated to eject and release the molding product representing the optical element, the total surface of the diffractive structure of the optical element is ejected, thereby, the surface of the diffractive structure is not deviated, and thus, it is possible to manufacture an optical element having thereon a microscopic step-wise surface like a diffractive structure which makes it possible to obtain more accurate and desired optical characteristics.

The invention described in (4) is an optical element having on its one side a surface in a microscopic step-wise shape like a diffractive structure which makes it possible to obtain highly accurate and desired optical characteristics.

What is claimed is:

1. An optical element molded between a first die and a second die which are jointed along a partition line, comprising:
a first optical surface on which a diffractive structure is provided;
a second optical surface being a refractive surface opposite to the first optical surface;
a flange having a flange surface provided around a periphery of the optical element, a first edge portion of the flange surface adjoining to the first optical surface and a second edge portion of the flange surface adjoining to the second optical surface,
wherein the second edge portion is positioned at the partition line between the first die and the second die.

2. The optical element of claim 1, wherein the flange has a side surface at the second edge portion and the side surface is tapered from the second edge portion.

3. The optical element of claim 1, wherein the optical element has an optical axis and the flange surface is parallel to the optical axis.

4. The optical element of claim 1, wherein the diffractive structure of the first optical surface is shaped in a plurality of ring-shaped diffractive zones.

5. The optical element of claim 4, wherein the plurality of ring-shaped diffractive zones is a plurality of ring-shaped steps.

6. A method of producing an optical element by a molding die, wherein the optical element has a first surface on which a diffractive structure including a plurality of stepped portions is formed and a second surface and the molding die comprises a first die having a fist concave shaped in a form corresponding the first surface of the optical element and a second die having a second concave shaped in a form corresponding to the second surface of the optical element, the method comprising steps of:
jointing the first die and the second die so that a void space corresponding to an external figure of the optical element is formed between the first concave of the first die and the second concave of the second die;
injecting a resin into the void space so as to mold the optical element;
separating the second die from the first die in which the molded optical element is left; and
removing the molded optical element from the first die.

7. The method of claim 6, wherein the first die comprises a pushing mechanism to push out the molded optical element from the fist die and the removing step comprises a step of pushing out the molded optical element from the first die.

8. A method of producing an optical element by a molding die, wherein the optical element has a first surface on which a diffractive structure including a plurality of stepped portions is formed and a second surface and the molding die comprises a first die having a fist concave shaped in a form corresponding the first surface of the optical element and a second die having a second concave shaped in a form corresponding to the second surface of the optical element, the method comprising steps of:
jointing the first die and the second die so that a void space corresponding to an external figure of the optical element is formed between the first concave of the first die and the second concave of the second die;
injecting a resin into the void space so as to mold the optical element;
separating the second die from the first die in which the molded optical element is left; and
pushing out the molded optical element from the first die with a pushing mechanism provided to the first die.
